(19) United States
(12) Patent Application Publication
(10) Pub. No.: US 2018/0312075 A1
(43) Pub. Date: Nov. 1, 2018

(54) HIGH VOLTAGE BUS SYSTEM FOR ELECTRIFIED VEHICLES

(71) Applicant: GM GLOBAL TECHNOLOGY OPERATIONS LLC, Detroit, MI (US)

(72) Inventors: AHMAD ALBANNA, DEARBORN HEIGHTS, MI (US); MOHAMMAD N. ANWAR, VAN BUREN TOWNSHIP, MI (US); BRENDAN M. CONLON, ROCHESTER HILLS, MI (US)

(73) Assignee: GM GLOBAL TECHNOLOGY OPERATIONS LLC, Detroit, MI (US)

(21) Appl. No.: 15/581,839

(22) Filed: Apr. 28, 2017

(51) Int. Cl. B60L 11/18

(52) U.S. Cl. CPC B60L 11/1868; B60L 11/1816; H02M 1/44; B60L 2210/14; B60L 2210/30; B60L 2210/12

(57) ABSTRACT

A high voltage bus system for electrified vehicles may include a direct current (DC) bus. A rectifier may be electrically coupled to the DC bus. The rectifier may be configured to receive an alternating current (AC) input and to provide a first DC electric power output to the DC bus. An energy storage system (ESS) may be electrically coupled to the DC bus. A converter may be electrically coupled to the ESS. The converter may be configured to provide a second DC electric power output to the DC bus. A load may be electrically coupled to the DC bus to receive the second DC electric power output.

### INTRODUCTION

The present invention generally relates to high voltage bus systems for electrified vehicles, and more particularly relates to the use of onboard battery chargers for supplying a secondary high voltage bus in electrified vehicles.

Electrified vehicles may include a traction motor that is powered by stored or generated electric energy. The traction motor may operate using a relatively high voltage power source, while some other vehicle systems may operate at a relatively low voltage. Separate energy storage systems may be used by the vehicle to supply the different high and low voltages. In applications such as electrified vehicles, direct current (DC) and/or alternating current (AC) may be employed for a variety of applications and systems that may operate under numerous variables,

Therefore, the power needs of an electrified vehicle may be diverse. Accordingly, it is desirable to provide efficient electrical system topologies for providing the desired power supplies. It is also desirable to provide methods, systems, and vehicles utilizing such topologies. Furthermore, other desirable features and characteristics will be apparent from the subsequent detailed description and the appended claims, taken in conjunction with the accompanying drawings and the foregoing technical field and introduction.

### SUMMARY

A number of examples provided herein may involve a high voltage bus system for an electrified vehicle that may include a DC bus. A rectifier may be electrically coupled to the DC bus. The rectifier may be configured to receive an AC input, and to provide a first DC electric power output to the DC bus. An energy storage system (ESS) may be electrically coupled to the DC bus. A converter may be electrically coupled to the ESS. The converter may be configured to provide a second DC electric power output to the DC bus. A load may be electrically coupled to the DC bus to receive the second DC electric power output.

Additional examples provided herein may involve a high voltage bus system for an electrified vehicle. A rectifier may be configured to receive an AC input and to provide a first DC electric power output. A converter may be electrically coupled to the rectifier to receive the first DC electric power output. The converter may be configured to provide a second DC electric power output. Another converter may be electrically coupled to the first converter to receive the second DC electric power output, and may be configured to provide a third DC electric power output. An ESS may be electrically coupled to the second converter to receive the third DC electric power output. A charging circuit may include the rectifier and the converters. The charging circuit may be configured to charge the ESS. A load may be electrically coupled to the charging circuit between the first and second converters. The charging circuit may supply an electric power input to the load.

Further examples provided herein may involve a high voltage bus system for an electrified vehicle. A rectifier may be configured to receive an AC input, and to provide a first DC electric power output. A converter may be electrically coupled to the rectifier to receive the first DC electric power output. The converter may be configured to provide a second DC electric power output. Another converter may be electrically coupled to the first converter to receive the second DC electric power output, and to provide a third DC electric power output. An ESS may be electrically coupled to the second converter to receive the third DC electric power output. A charging circuit may include the rectifier and the converters. The charging circuit may be configured to charge the ESS. An auxiliary power module (APM), may be electrically coupled to the charging circuit between the first and second converters. The ESS may supply an electric power input through the second converter and to the APM. The APM may be configured to provide a fourth DC electric power output.

### BRIEF DESCRIPTION OF THE DRAWINGS

A number of examples will hereinafter be described in conjunction with the following drawing figures wherein:

FIG. 1 is a functional block diagram of an electrified vehicle in accordance with exemplary embodiments; and

FIG. 2 is a schematic diagram of electric bus topologies according to a number of exemplary variations.

### DETAILED DESCRIPTION

The following detailed description is merely exemplary in nature and is not intended to limit the application or its uses. Furthermore, there is no intention to be bound by any expressed or implied theory presented in the preceding technical field, introduction, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

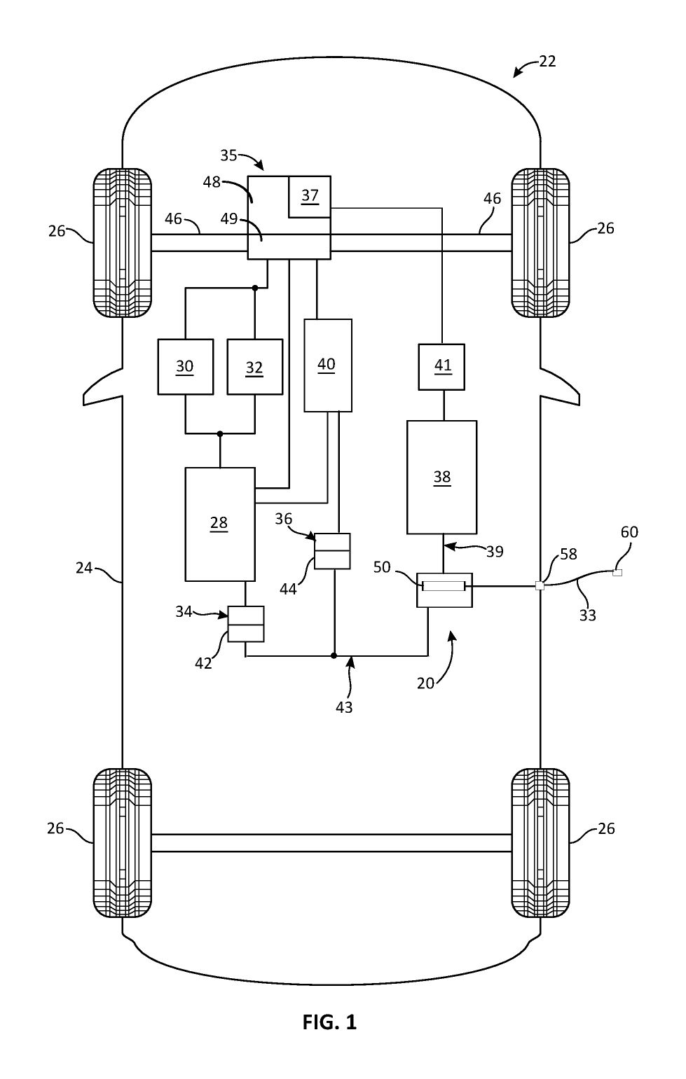

In a number of examples, a DC bus with battery charging capability may be employed in a power consuming appliance. The appliance may be any equipment that uses an ESS for which charging may be needed. In a number of examples, the appliance may, for example, be a vehicle, a generator, a portable power supply, or any ESS powered equipment whether self-propelled, portable or stationary. In a number of examples, the power consuming appliance may be a vehicle 22, such as indicated in FIG. 1. The vehicle 22 may be any one of a number of different types of land, sea, or air vehicles, and in certain embodiments, may for example, be a passenger automobile of any configuration. As depicted in FIG. 1, the vehicle 22 may include, in addition to the above-referenced battery charger system 20, any, or any combination of: a body 24, wheels 26, an electronic control system or systems 28, a steering system 30, a braking system 32, an air conditioning system 34, and/or other accessory systems 36. The wheels 26 may each be rotationally coupled to the body 24. In various embodiments the vehicle 22 may differ from that depicted in FIG. 1. For example, in certain embodiments the number of wheels 26 may vary. By way of additional examples, in various embodiments the vehicle 22 may not have wheels 26 that react against a roadway, but may include another method of converting torque into motion, for example through pitched blades operating against a fluid.

In the examples illustrated in FIG. 1, the vehicle 22 may include at least one propulsion system 35, which in these examples may drive the wheels 26. The propulsion system 35 may include an engine and/or an electric motor, which may include a device such as a motor 37. The propulsion system 35 may be mechanically coupled to at least some of the wheels 26 through one or more drive shafts 46. In some examples, the propulsion system 35 may include the engine 48 and/or a transmission 49 to provide variable output. In a number of examples, the motor 37 may be coupled to the transmission 49. In a number of examples, such as for a full electric vehicle, the engine 48 and/or the transmission 49 may not be necessary, and may be omitted, or replaced by another appropriate device.

In a number of examples, the motor 37 may be one or more electric motor-generators and/or may be more than one motor. The motor 37 may be powered by a DC power source such as an energy storage system (ESS) 38, which may be a rechargeable energy storage system, and is a number of examples may be a battery or batteries. In this example the motor 37 may be an AC motor and the power supply from the ESS 38 may be delivered through a traction power inverter module (TPIM) 41. In a number of examples, the propulsion system may include a combustion engine 48, such as in a hybrid arrangement with the motor 37, or in another configuration. In a number of examples, the ESS 38 may be a high voltage battery system, such as one that may operate at tens, or hundreds of volts, and may be connected to a DC bus 39. In one example, the ESS 38 may be a 600 volt DC (VDC), system and therefore, the DC bus 39 at the ESS 38 may be a high voltage bus. A low voltage battery system 40, such as one with a 12 VDC battery, may be included for various systems of the vehicle 22.

In a number of examples, the electronic control system(s) 28 may include integrated or separately operating systems. The electronic control system(s) 28 may include variations of components or modules that may be packaged together, or may be separate and physically mounted at various distributed locations of the vehicle 22. The electronic control system(s) 28 may include one or more of an engine control module, a body control module, a transmission control module, a battery management system, a vehicle integration control module, and/or one or more other components to control a system or systems of the vehicle 22. In a number of examples an air conditioning control module (ACCM) 42 and an accessory power module (APM) 44 may be packaged separately as shown, or in other examples as part of the electronic control system(s) 28. The ACCM 42 may control the air conditioning system 34 and the APM 44 may control the accessory systems 36. The ACCM 42 and the APM 44 may be connected to a bus, which may be electrically coupled with the battery charger system 20. The bus may be referred to as a secondary high voltage bus 43. In a number of examples, parts of the battery charger system 20, may be included in the electronic control system(s) 28 or may be communicatively coupled therewith.

In the examples illustrated in FIG. 1, the steering system 30 may control the direction of at least some of the wheels 26. In certain embodiments, the vehicle 22 may be autonomous, utilizing steering commands that are generated by a processor, such as in the electronic control system(s) 28. The braking system 32 may provide braking for the vehicle 22. The braking system 32 may receive inputs from a driver via a brake pedal (not shown), which may control vehicle deceleration through wheel brakes (not shown). A driver may also provide inputs via an accelerator pedal (not shown) to command a desired speed or acceleration of the vehicle. Response of the vehicle 22 to these inputs may be effected, at least in part, through an output speed and/or torque of the motor 37. Similar to the description above regarding possible variations for the vehicle 22, in certain embodiments steering, braking, and/or acceleration may be commanded by a computer instead of by a driver, such as through autonomous capability.

The electronic control system(s) 28, and/or other modules, systems or controllers described herein, such as the APM 44, ACCM 42, TPIM 41, and others, may include one or more processor, memory, interface, storage device, and/or bus. Any type of suitable memory may be employed. For example, the memory may include various types of dynamic random access memory (DRAM) such as SDRAM, various types of static RAM (SRAM), and/or various types of non-volatile memory (PROM, EPROM, and flash). In certain examples, the memory may be located on and/or co-located on the same computer chip as the processor. A processor may perform computation and control functions of a controller, and may comprise any type of processor or multiple processors, single integrated circuits such as a microprocessor, or any suitable number of integrated circuit devices and/or circuit boards working in cooperation to accomplish the functions of a processing unit. During operation, a processor may execute one or more programs contained within memory and, as such, may control the general operation of a controller or a computer system of the controller. Processors may generally execute the processes described herein.

In a number of examples, the body 24 of the vehicle 22 may carry a number of components of the battery charger system 20. These components are referred to as onboard the vehicle. In a number of examples, the battery charger system 20 may employ an onboard charging system topology that may be compatible with a variety of charging system variations. In a number of examples, the battery charger system 20 may include a charging circuit 50. Charging circuit 50 may include elements residing onboard the vehicle 22. For example, the charging circuit 50 may include a power adaptation stage to condition, convert, and/or control power received onboard the vehicle 22. A charging connector 58 may be provided for the battery charger system 20, and may be connectable with a power source 60 for charging of the ESS 38. The power source 60 may be located offboard the vehicle 22. The power source 60 may be any compatible power source, and in a number of examples, may be part of infrastructure such as a power distribution system, may be a generator unit, or may be another power source. In other examples, the power source 60 may be a compatible source of any number of variations. The charging connector 58 may be coupled with the power source 60, such as through a releasable wired connection that may include conductors 33. In other examples, the battery charger system 20 may be coupled with the power source 60 wirelessly, such as through inductive coupling. In the examples of FIG. 1, the conductors 33 may include a number of line conductors for the desired number of phases, and a protective earth conductor. Through the charging connector 58, the vehicle 22 and/or the power source 60 are provided with a port or mating connector to provide a releasable connection between the two. In some examples, an extendable cable containing the conductors 33 may be fixed to, or otherwise provided with, one of the vehicle 22, or the power source 60. When charging of the ESS 38 is desired, the vehicle 22 and the power source 60 may be brought in proximity with one another to enable connection through the cable. The charging process may include control through the charging circuit 50, which for example, may include any, or any combination of, electrically coupled stages for: surge protection; filtering; rectification; power factor correction (PFC); and/or conversion. In other examples, charging may be controlled to provide multiple stages with different current and/or voltage modes, and/or system protections such as isolation. Accordingly, in a number of examples the charging circuit 50 may provide onboard control of a number of factors in the charging process when power is received through the releasable wired connection with the power source 60, and is delivered to the ESS 38.

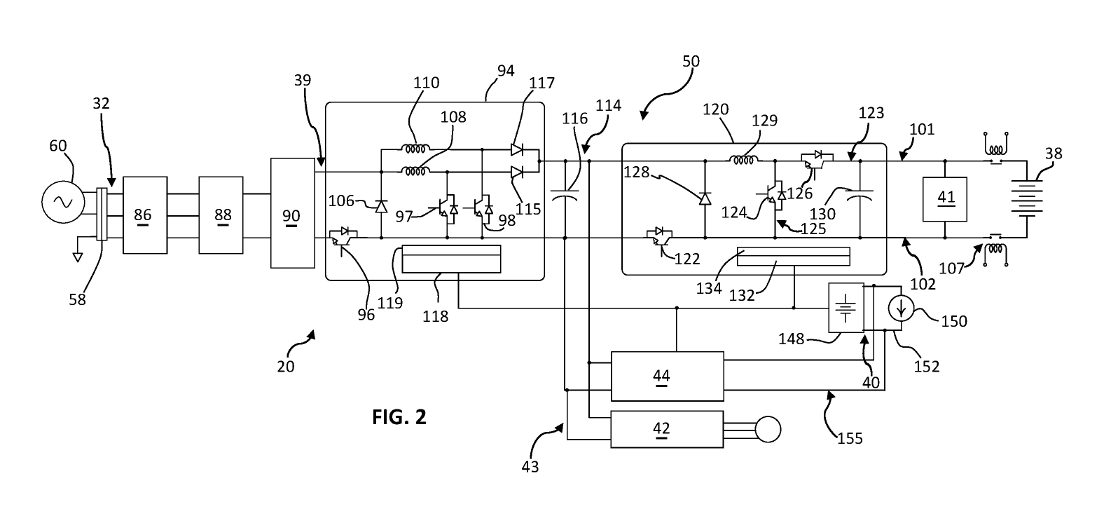

Referring to FIG. 2, in a number of examples the battery charger system 20 may include the charging circuit 50. The charging circuit 50 may include a connection with the power source 60. In some examples, the power source 60 may be of a type normally available in a residence, such as a one-hundred-twenty, or a two-hundred-forty volt, sixty hertz supply, with ground. A ground fault circuit interrupter (GFCI) device (not shown), may be used to protect against ground faults in an electrical circuit. The AC voltage may be received onboard the vehicle 22 through a protective device such as a surge protector 86 to provide protection from voltage variation in the supply. The AC voltage may be conducted from the surge protector 86 through a filter 88 such as to reduce the transfer of electromagnetic noise. In a number of examples, the filter 88 may include electromagnetic compatibility functionality to avoid effects caused by electromagnetic interference. The AC voltage may continue from the filter 88 to a rectifier 90, where the AC voltage may be converted to DC. The rectifier 90 may include diodes, silicon-controlled rectifiers (SCRs), insulated gate bipolar transistors (IGBTs), or other appropriate devices connected in a rectifier circuit, such as in a bridge configuration.

On the opposite side of the rectifier 90 from the power source 60, the DC bus 39 may begin and may receive the DC electric power output from the rectifier 90 for delivery to the ESS 38. The DC bus 39 may be utilized for charging of the ESS 38. The DC bus 39 may include rails 101 and 102. In a number of examples, one or more TPIM 41 may be electrically connected to the DC bus rails 101, 102 for supply of power from the ESS 38. The DC bus rails 101, 102 at the TPIMs 41, may provide a high voltage bus for the vehicle 22. The TPIMs 41 may commutate the motor 37 through the use of power electronics components. The motor 37 of FIG. 1 may be used for vehicle traction or to power other systems. Examples of components (not illustrated), of the TPIMs 41 may include a power board containing semiconductor switches and inverter circuitry, DC bus capacitors, filters, controller and gate drive boards, and sensors. Control algorithms for the motor 37 may be programmed into the control boards. A mechanical disconnect 107 may be included in the DC bus 39 and may be located between the ESS 38 and the TPIM(s) 41, to connect the DC bus 39 to the ESS 38, or to isolate the ESS 38 from the remainder of the DC bus 39.

In a number of examples, a converter 94 may be connected in the DC bus 39 to receive DC electric power output from the rectifier 90. The converter 94 may include a number of switches 96, 97 98. The switches 96, 97 98 may include a semiconductor device as the switching element, such as a metal oxide semiconductor field-effect transistor (MOSFET), IGBT, gate turn-off thyristor (GTO), or another electronic switching device. The switching elements may be provided in combination with antiparallel diodes. The switches 96, 97, 98 may be controllable for conducting (ON), and blocking (OFF), states. The switch 96 may be connected in the DC bus rail 102, which at this point may control connection of the rail 102 with the rectifier 90. Accordingly, the switch 96 may be set to the OFF state to disconnect from the power source 60, or to the ON state to connect therewith. The switches 97 and 98, along with a diode 106, may each be connected between the DC bus rails 101, 102. The converter 94 may include parallel switching converter circuits. A first circuit may include an inductor 108, the switch 97 and the diode 106. A second circuit include an inductor 110, the switch 98 and the diode 106. Outputs from the inductors 108, 110 may be routed through the diodes 115, 117 respectively, and may then be connected together to provide a common output from the converter 94. It should be appreciated that while two inductor circuits are illustrated, a different number may be included in other examples.

In a number of examples, a capacitor, referred to as DC link capacitor 116, may be connected across the DC bus rails 101, 102, and may be charged by the DC electric power output from the inductors 108, 110. The converter 94 may be electrically coupled with a controller 118 through a gate driver 119. The gate driver 119 may receive a low-power input from the controller 118 and produce a high-current drive input for the gates of the semiconductor devices of switches 96, 97, 98. The controller 118 provides switching control for the converter 94, controlling the switches 96, 97, 98 according to control logic that may be programmed for responses to operation modes, voltage status, and other factors. In response to the controller 118, switch 96 may be set to the ON state, and the switches 97, 98 may be selectively switched ON and OFF for charging and discharge of the inductors 108, 110, respectively. For example, when switch 97 is ON, rectified input voltage charges inductor 108. When switch 97 is OFF, energy stored in inductor 108 is discharged through the diode 115 to DC link capacitor 116. Similarly, when switch 98 is ON, rectified input voltage charges inductor 110. When switch 98 is OFF, energy stored in inductor 110 is discharged through the diode 117 to DC link capacitor 116. The two circuits may be operated 180 degrees out of phase. With current from the inductors 108, 110 out of phase, cancellation may reduce periodic variation in the DC bus 39, such as may be produced by high frequency switching or which may remain from the AC source 60. In addition, paralleling the semiconductors may reduce conduction losses, and may enable the use of a smaller capacitor for the DC link capacitor 116. In one example, the voltage level may be increased through the converter 94 to 450 VDC at the DC link capacitor 116, it being understood that the amount of boost provided by the converter 94 may be designed to suit the application.

In a number of examples, a second converter 120 may be connected in the DC bus 39 between the DC link capacitor 116 and the ESS 38. The converter 120 may be either a buck or a boost converter depending on the voltage of the ESS 38 and the voltage achieved by the converter 94. For example, the second converter may be constructed to provide a step down in voltage when the ESS 38 voltage may be lower than the voltage output from the converter 94. Alternatively, the second converter may be constructed to provide a step up in voltage when the ESS 38 voltage is higher than the voltage of the output from the converter 94. In the examples of FIG. 2, the converter 120 may step up voltage. The converter 120 may include a number of switches, 122, 124 and 126. The switches 122, 124, 126 may include a semiconductor device, such as described above, as the switching element. The switches 122, 124, 126 may be provided with antiparallel diodes, and may be controllable for ON and OFF states. The switch 122 may be connected in the DC bus rail 102, Accordingly, the switch 122 may be set to the OFF state to disconnect from the DC link capacitor 116, and power source 60, and to the ON state to provide connection. The switch 124 may be connected between the DC bus rails 101, 102. The switch 126 may be connected in the DC bus rail 101. The converter 120 may include a diode 128, connected between the DC bus rails 101, 102. The converter 120 includes an inductor 129 that may be connected in the DC bus rail 101. The converter 120 may include a capacitor 130 connected between the DC bus rails 101, 102. The converter 120 may be coupled with a controller 132 through a gate driver 134. The gate driver 134 may receive a low-power input from the controller 119 and produce a high-current drive input for the gates of the semiconductor devices of switches 122, 124, 126. The controller 119 provides switching control for the converter 120, controlling the switches 122, 124, 126 according to control logic that may be programmed for responses to operation modes, voltage status, and other factors.

In a number of examples, the converter 120 may include a boost circuit 123. In response to the controller 132, the switch 122 may be set to the ON state and the switch 96 may be set to the OFF state to transfer charge from the DC link capacitor 116 to the ESS 38. The converter 120 may be switched to utilize inductor 129 and capacitor 130 to boost voltage through the converter 120. For example, switch 124 may be placed in the ON state to build energy in the inductor 129. During this stage, charge on the capacitor 130 may supply the ESS 38. Alternatively, the switch 124 may be placed in the OFF state to supply charge from the inductor 129 to the ESS 38 and to charge the capacitor 130. Switch 126 is in the OFF state during boosting, with inductor current flowing through diode of switch 126 whenever switch 124 is OFF. In one example, the voltage level may be increased through the converter 120 to from 450 VDC to 600 VDC at the ESS 38, it being understood that the amount of boost (or buck), provided by the converter 120 may be designed to suit the application. In a number of examples, the converter 94 may provide a DC electric power output, using DC link capacitor 116, to supply power to the converter 120. The converter 120 may use the DC supply to provide a DC electric power output to charge the ESS 38, Isolation may be provided without a transformer through the switches 96, 122.

In a number of examples, the converter 120 may be bi-directional to provide reduced voltage from the ESS 38 to the DC bus 39, such as at the node 114. When the vehicle 22 is in use, the charging circuit 50 may not be in use to charge the ESS from the power source 60, and so may be available for other uses. For example, the converter 120 may include a buck circuit 125 to operate in step down mode to supply power from the ESS 38 to the node 114. In response to the controller 132, the converter 120 may be switched to reduce voltage as power transfers from the ESS 38. For example, for step up (boost), whenever the switch 124 and the switch 122 are OFF, the current of the inductor 129 will continue to supply the load via the diode of switch 126, and will continue to flow and freewheel via the diode 128 to complete the current path. The DC link capacitor 116 helps supply the load. The converter 120 may provide a stepped down DC electric power output and the resulting power available at node 114 is then available for use.

A number of DC powered components may be electrically coupled with the DC bus 39, such as at node 114 through the secondary high voltage bus 43, to use the power supplied from the ESS 38 through converter 120. Due to the location of node 114 on the DC bus 39, between the converters 94, 120, the available voltage may be a high voltage. Accordingly, in an electrified vehicle such as the vehicle 22, this may provide a secondary high voltage bus 43 for use by powered components. In one example, the available voltage at the secondary high voltage bus 43 may be 450 VDC, which may be compatible with components such as the APM 44, ACCM 42, and/or other modules. In this example, these modules may have been designed to operate with a 450 VDC supply, and in other examples where the vehicle 22 uses a higher voltage ESS 38, the existing modules may be used with the step down operation of converter 120. In examples where the ESS 38 operates at a lower voltage than the APM 44 and ACCM 42, the converter 120 may be configured for step up operation when supplying the node 114 from the ESS 38.

In a number of examples, the vehicle 22 may have the low voltage battery system 40, which may employ a twelve-volt battery 148 for various low voltage loads 150 supplied through a low voltage DC bus 152. In a number of examples, the battery 148 may power the controllers 118, 132 and the APM 44 for wake-up when power is not available at the node 114. For example, when the power source 60 is disconnected, using the battery 148 as a power source may help launch the charging circuit 50. Initially, there may be no voltage at node 114. The battery 148 may supply power to the controllers 119, 132 at the start, and once voltage is developed at the node 114, the APM 44 may then supply the controllers 119, 132, and other loads such as through conductors 155 connected with the low voltage DC bus 152.

While examples have been presented in the foregoing detailed description, it should be appreciated that a vast number of variations exist. It should also be appreciated that details are only examples, and are not intended to limit the disclosure's scope, applicability, or configurations, in any way. Rather, the foregoing detailed description will provide those skilled in the art with a convenient road map for implementing examples of the invention. It being understood that various changes may be made in the function and arrangement of elements described in examples without departing from the scope as set forth in the appended claims.

What is claimed is:

1. A high voltage bus system for an electrified vehicle comprising:
a direct current (DC) bus;
a rectifier electrically coupled to the DC bus, the rectifier configured to receive an alternating current (AC) input and to provide a first DC electric power output to the DC bus;
an energy storage system (ESS) electrically coupled to the DC bus;
a converter electrically coupled to the ESS, the converter configured to provide a second DC electric power output to the DC bus; and
a load electrically coupled to the DC bus to receive the second DC electric power output.

2. The high voltage bus system of claim 1 comprising:
a second converter electrically coupled to the DC bus between the rectifier and the converter.

3. The high voltage bus system of claim 2 comprising:
a capacitor electrically coupled across the DC bus between the converter and the second converter.

4. The high voltage bus system of claim 1 comprising:
a secondary DC bus electrically coupled with the DC bus, and the secondary DC bus is electrically coupled with the load;
wherein the ESS provides a first DC electric power source at a first voltage and the secondary DC bus provides a second DC electric power source at a second voltage that is different than the first voltage.

5. The high voltage bus system of claim 4 comprising:
a battery providing a third DC electric power source at a third voltage that is lower than both of the first and second voltages; and
a low voltage DC bus electrically coupled to the battery, wherein the load comprises an auxiliary power module (APM) electrically coupled to the low voltage DC bus, the APM providing a third DC electric power output to the low voltage DC bus.

6. The high voltage bus system of claim 1 comprising:
a connector configured to receive the AC input, the connector electrically coupled with the rectifier.

7. The high voltage bus system of claim 6 comprising:
a vehicle, wherein the connector comprises a charging port on the vehicle and wherein the ESS is chargeable through the rectifier and the converter.

8. The high voltage bus system of claim 7 wherein:
the converter is bidirectional and comprises a boost circuit to increase voltage and a buck circuit to decrease voltage.

9. The high voltage bus system of claim 1 comprising:
a traction power inverter module (TPIM) for powering the electrified vehicle, the TPIM electrically coupled to the DC bus between the converter and the ESS.

10. The high voltage bus system of claim 1 comprising:
a charging circuit electrically coupled to the DC bus, the charging circuit configured to charge the ESS, wherein the charging circuit includes the converter.

11. The high voltage bus system of claim 10 wherein:
the DC bus comprises a first rail and a second rail, and the charging circuit comprises a second converter electrically coupled to the DC bus between the rectifier and the converter, the second converter comprising a pair of inductors electrically connected in parallel in the first rail.

12. A high voltage bus system for an electrified vehicle comprising:
a rectifier configured to receive an alternating current (AC) input and to provide a first DC electric power output;
a first converter electrically coupled to the rectifier to receive the first DC electric power output, the first converter configured to provide a second DC electric power output;
a second converter electrically coupled to the first converter to receive the second DC electric power output, the second converter configured to provide a third DC electric power output;
an energy storage system (ESS) electrically coupled to the second converter to receive the third DC electric power output;
a charging circuit comprising the rectifier and the first and second converters, the charging circuit configured to charge the ESS; and
a load electrically coupled to the charging circuit between the first and second converters, the charging circuit supplying an electric power input to the load.

13. The high voltage bus system of claim 12 comprising:
a capacitor electrically coupled in the charging circuit between the first and second converters.

14. The high voltage bus system of claim 12 comprising:
a secondary DC bus electrically coupled with the charging circuit and with the load, the ESS providing a first DC electric power source configured to supply the second converter at a first voltage, and the secondary DC bus providing a second DC electric power source configured to supply the load at a second voltage that is lower than the first voltage.

15. The high voltage bus system of claim 14 comprising:
a battery providing a third DC electric power source at a third voltage that is lower than the second voltage.

16. The high voltage bus system of claim 15 wherein:
the load comprises an auxiliary power module (APM) electrically coupled to the secondary DC bus, the APM providing a third DC electric power output to the battery.

17. The high voltage bus system of claim 12 comprising:
a connector configured to receive the AC input, the connector electrically coupled with the rectifier.

18. The high voltage bus system of claim 12 wherein:
the second converter comprises a boost circuit to increase voltage and a buck circuit to decrease voltage.

19. The high voltage bus system of claim 12 wherein:
the first converter comprising a pair of inductors electrically connected in parallel in the charging circuit.

20. A high voltage bus system for an electrified vehicle comprising:
a rectifier configured to receive an alternating current (AC) input and to provide a first DC electric power output;
a first converter electrically coupled to the rectifier to receive the first DC electric power output, the first converter configured to provide a second DC electric power output;
a second converter electrically coupled to the first converter to receive the second DC electric power output, the second converter configured to provide a third DC electric power output;
an energy storage system (ESS) electrically coupled to the second converter to receive the third DC electric power output;
a charging circuit comprising the rectifier and the first and second converters, the charging circuit configured to charge the ESS; and
an auxiliary power module (APM) electrically coupled to the charging circuit between the first and second converters, the ESS supplying an electric power input through the second converter and to the APM, the APM configured to provide a fourth DC electric power output.
